(19) United States
(12) Patent Application Publication
(10) Pub. No.: US 2004/0219342 A1
(43) Pub. Date: Nov. 4, 2004

(54) Electronic substrate with direct inner layer component interconnection

(76) Inventors: David W. Boggs, Hillsboro, OR (US); Daryl A. Sato, Portland, OR (US); John H. Dungan, Hillsboro, OR (US); Gary Paek, Beaverton, OR (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/750,560

(22) Filed: Dec. 31, 2003

Related U.S. Application Data
(63) Continuation-in-part of application No. 10/337,949, filed on Jan. 7, 2003.

(51) Int. Cl. B32B 3/00

(52) U.S. Cl. 428/209

(57) ABSTRACT

An electronic substrate for interconnecting electronic components comprises a substrate having one or more conductive inner layers and one or more interconnect cavities extending into the substrate to expose one or more of the inner layers.

### CROSS-REFERENCE TO RELATED APPLICATIONS

This is a continuation-in-part of application Ser. No. 10/337,949, filed Jan. 7, 2003.

### FIELD OF THE INVENTION

The present invention relates to microelectronic assemblies and, more particularly, to substrate and methods for providing electrical interconnects to facilitate high-performance and high-density component interconnection.

### BACKGROUND OF INVENTION

It is common that electrical assemblies comprise at least one substrate that is used as a structural platform as well as to electrically interconnect one electrical component with another. The substrate is commonly a relatively rigid panel that comprises a variety of electrical interconnects that run through, within, and/or upon the panel. Examples of substrates include, but are not limited to, printed circuit boards (PCB), motherboards, and carrier substrates within microelectronic packages.

One long-standing method of interlayer communication between interconnects is the well established process of providing the substrate with vias. Vias are essentially through holes that pass from one side of the substrate to the other side, passing through predetermined interconnect layers, exposing a portion of the interconnect layer at the through hole wall. The through hole is plated with a conductive layer, which interconnects the exposed interconnect layers.

One method of interconnecting electrical components to the substrate, or one substrate to another substrate, incorporates surface mount technology (SMT). The SMT electrical component is provided with flat electrical interconnects known as land pads. Surface mount technology electrical components are widely used because of their compact size and simplicity of interconnection. Examples of SMT electrical components include, but are not limited to, flip chip-ball grid array (FC-BGA) packaging and chip-scale packaging.

FIG. 1 is a top view of a substrate 10 which comprises a plurality of SMT bond pads 20 on the surface 11 of the substrate 10 adjacent to a corresponding plated through hole via 29 and electrically interconnected therewith with a link 22. FIG. 2 is a cross-sectional view of the substrate 10 showing the interconnection of surface components with the plated through hole via 29 extending through the thickness of the substrate 10. The plated through hole via 29 is interconnected with a plurality of internal conductive inner layers 28. A SMT component 30 is shown interconnected to the SMT bond pads 20 with reflowable electrical interface material 32, shown here as a solder ball.

Providing the bond pad 20 and link 22, as well as the through hole via 29, for each interconnection takes up a considerable amount of area on the surface 11 of the substrate 10. This limits the number of interconnections that a substrate 10 can provide. Further, the intrusion into the thickness of the substrate 10 of the through hole via 29 limits the available volume within the substrate 10 that can be used to provide interlayer interconnections using internal conductive inner layers 28, and increases the complexity of substrate design regarding placement of those interlayer interconnections.

### BRIEF DESCRIPTION OF DRAWINGS

Embodiments of the present invention will be described referencing the accompanying drawings in which like references denote similar elements, and in which:

FIG. 1 is a top view of a substrate which comprises a plurality of SMT bond pads on the surface of the substrate adjacent to a corresponding through hole via and electrically interconnected therewith with a link;

FIG. 2 is a cross-sectional view of the substrate showing the interconnection of surface components with the plated through hole via extending through the thickness of the substrate;

FIGS. 3 and 4 are top and cross-sectional views of a substrate which comprises a plurality of interconnect cavities, in accordance with an embodiment of the present invention;

FIGS. 5 and 6 are top and cross-sectional views of a substrate which comprises a plurality of interconnect cavities, in accordance with an embodiment of the present invention; and

FIGS. 7 and 8 are top and cross-sectional views of a substrate which comprises a plurality of interconnect cavities, in accordance with an embodiment of the present invention.

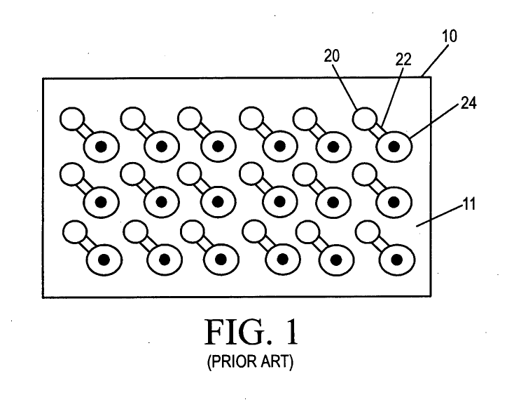

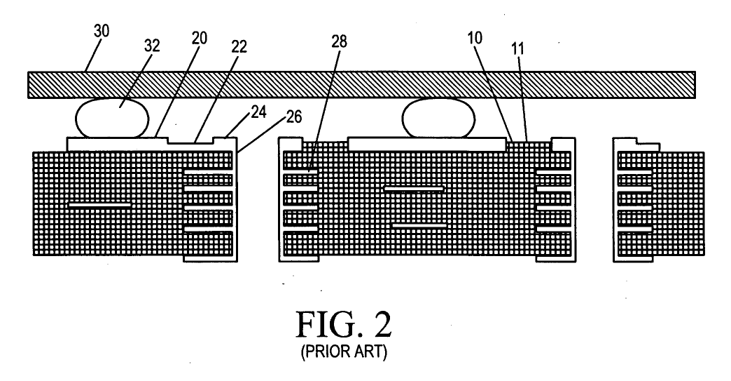

### DESCRIPTION

In the following detailed description, reference is made to the accompanying drawings which form a part hereof wherein like numerals designate like parts throughout, and in which is shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Embodiments of substrate in accordance with the present invention provide interconnect cavities for direct electrical interconnection between surface mount technology (SMT) components and internal conductive inner layers. In various embodiments of the present invention, but not limited thereto, the cavities are used to: expose one or more internal conductive inner layers which are at different locations within the thickness of the substrate; to interconnect two or more internal conductive inner layers which are at different locations within the thickness of the substrate with a conductive liner; and to interconnect a conductive surface outer layer with one or more internal conductive inner layers which are at different locations within the thickness of the substrate with or without a conductive liner.

Interconnections comprising interconnect cavities in accordance with the present invention, provide interconnections requiring less substrate surface area and internal volume than conventional through hole vias. Further, interconnect cavities allow for a reduction of the space between the SMT component and the substrate as the interconnect material extends below the surface of the substrate. Further, interconnect cavities accommodate traditional interconnect materials known in the art, such as, but not limited to, reflowable electrically conductive interconnect material, such as solder paste and solder balls, and non-reflowable electrically conductive interconnect material, such as curable conductive paste and adhesives. Examples of suitable reflowable interconnect material include, but are not limited to, eutectic Sn-3.5Ag, Sn-37Pb, Sn-5Sb, Sn-Cu, Sn-35In, Sn-40Bi, and Sn—Ag—Cu solder.

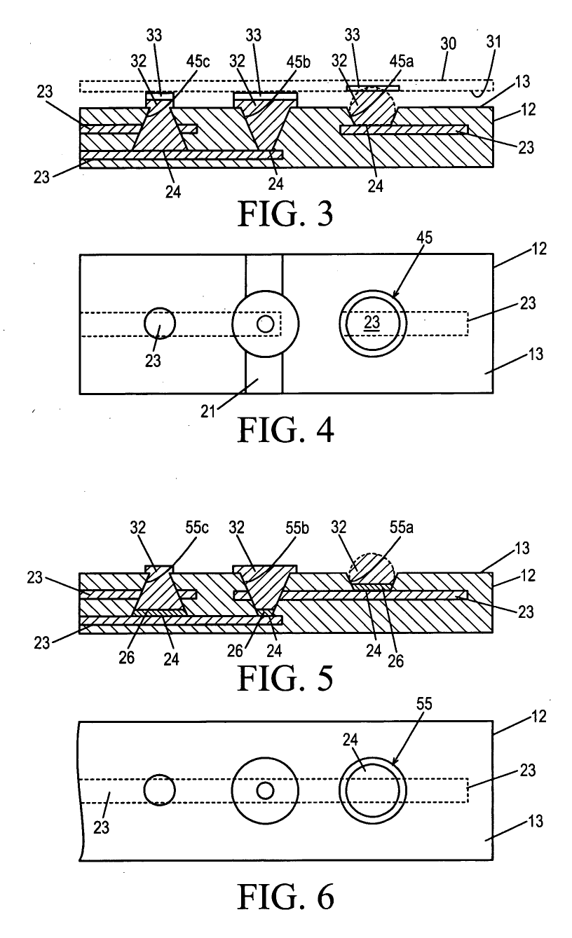

FIGS. 3 and 4 are cross-sectional and top views of a substrate 12 which comprises a plurality of interconnect cavities 45a,b,c, in accordance with embodiments of the present invention. The substrate 12 is provided with multiple conductive inner layers 23 and surface layers 21 using well known fabrication techniques for circuit board fabrication, such as, but not limited to, multilayer lamination.

Each interconnect cavity 45a,b,c extends from the substrate surface 13 to one or more internal conductive inner layers 23 directly beneath the interconnect cavity 45a,b,c. Each interconnect cavity 45a,b,c is formed using known techniques, such as, but not limited to, those used to produce blind vias. In embodiments in accordance with methods of the present invention, the interconnect cavity 45a,b,c is formed in the substrate using techniques, such as, but not limited to, laser ablation, plasma etch, and photo-imageable dielectric processes.

Each interconnect cavity 45a,b,c exposes one or more inner layers 23 with one of the inner layers 23 exposed at the cavity base 24. The shape of the interconnect cavity 45a,b,c is adapted for a particular purpose. For example, the first interconnect cavity 45a has a shape of an inwardly-extending cone (positive slope wall), which conforms more closely to the shape of a solder ball. The third interconnect cavity 45c is shaped as an outwardly-extending cone (negative slope wall) which provides an enlarged cavity base 24. Other cavity shapes are anticipated, including, but not limited to, cylindrical or straight-walled (not shown).

The interconnect cavities 45a,b,c are adapted to electrically interconnect conductive inner layers 23, surface layers 21, and/or one or more external electronic components 30. The first interconnect cavity 45a is adapted to expose an inner layer 23 for interconnection with an external electronic component 30. The second interconnect cavity 45b is adapted to expose another inner layer 23 for interconnection with an external electronic component 30. The second interconnect cavity 45b also passes through a surface layer 21 for simultaneous interconnection of an inner layer 23 and surface layer 21 with an external electronic component 30. The third interconnect cavity 45c passes through and exposes multiple inner layers 23 for simultaneous interconnection between more than one inner layer 23 and an external electronic component 30. Other combinations of one or more inner layers 23 at various locations within the thickness of the substrate 12, and surface layers 21, are anticipated.

As shown in FIG. 3, the interconnect cavities 45a,b,c are adapted to be provided with interconnect material 32 which is used as an electrical interconnect. The interconnect material 32 comprises any suitable electrically conductive interconnect material known in the art. Suitable interconnect material 32 includes, but is not limited to, reflowable electrically conductive interconnect material, such as solder paste and solder balls, and non-reflowable electrically conductive interconnect material, such as curable conductive paste and adhesives, as discussed above.

Various techniques for depositing the interconnect material 32 onto the substrate 12 are anticipated. Such techniques include, but are not limited to, pick and place techniques, such as to place solid solder or solder balls within the interconnect cavities 45a,b,c, and deposition techniques, such as to pass through a nozzle or silkscreen for deposition within the interconnect cavities 45a,b,c. Techniques are also anticipated, such as those that place the interconnect material 32 onto the external electronic component 30 rather than the interconnect cavities 45a,b,c prior to assembly.

In an embodiment of the methods in accordance with the present invention, a surface mount technology (SMT) electronic component 30, shown in phantom, is electrically interconnected with the interconnect cavities 45a,b,c using a well-known reflow process. Each of the plurality of land pads 33 on the interconnect surface 31 of the SMT component 30 is provided with electrically conductive reflowable interconnect material 32, shown in FIG. 3 as a solder ball. Each land pad 33 is registered with a corresponding interconnect cavity 45a,b,c with the interconnect material 32 positioned there between. The assembly undergoes a reflow process wherein the interconnect material 32 reflows to interconnect the land pads 33 with the one or more inner layers 23 exposed by the interconnect cavities 45a,b,c and a surface layer if present.

FIGS. 5 and 6 are cross-sectional and top views of a substrate 12 which comprises a plurality of interconnect cavities 55a,b,c, in accordance with embodiments of the present invention. In similar configuration with the interconnect cavities 45a,b,c of the embodiments above, each interconnect cavity 55a,b,c extends from the substrate surface 13 to a conductive inner layer 23 beneath the interconnect cavity 55a,b,c with a conductive inner layer 23 exposed at the base 24. The base 24 of each interconnect cavity 45a,b,c is provided with a conductive material to form a conductive layer or pad 26. The pad 26 is interconnected with the conductive inner layer 23, using known techniques, such as, but not limited to, electroplating. The conductive pad 26 provides a number of benefits depending on the interconnect cavity 55a,b,c configuration with respect to the inner layer 23. The benefits include, but are not limited to, providing a larger contact surface area for the interconnection with the interconnect material 32, and providing an intermediate layer of a material suitable for interconnection with the interconnect material 32.

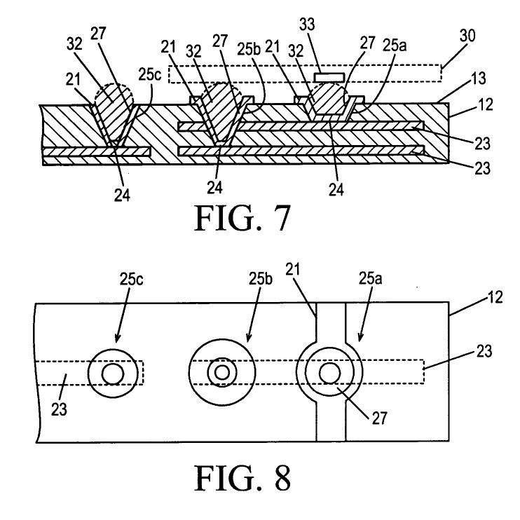

FIGS. 7 and 8 are cross-sectional and top views of a substrate 13 which comprises a plurality of interconnect cavities 25a,b,c, in accordance with embodiments of the present invention. In similar configuration with the interconnect cavities 45a,b,c of the embodiments above, each interconnect cavity 25a,b,c extends from the substrate surface 13 to one or more conductive inner layers 23, with a conductive inner layer 23 exposed at the base 24. The interconnect cavities 25a,b,c further comprise a conductive liner 27 provided using known techniques, including plating and vapor deposition, among others.

The conductive liner 27 provides a number of benefits depending on the interconnect cavity 25a,b,c configuration with respect to the inner layer 23. The benefits include, but are not limited to, providing a larger interconnect surface area, providing an intermediate layer having a material suitable for interconnection with the interconnect material 32, and providing an interconnection between multiple inner layers 23 and/or surface layers 21 if present.

Substrate provided in accordance with embodiments of the present invention provides direct inner layer component attachment using interconnect cavities. Compared with through hole vias, interconnect cavities consume less substrate surface allowing for higher interconnect density substrate, or smaller substrate with the same number of interconnects. Interconnect cavities do not extend through the substrate and therefore consume less inter-substrate volume, allowing for higher inner layer densities and easier accommodation of inner layer orientations.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. An electronic substrate for interconnecting electronic components, comprising:
a substrate having one or more conductive inner layers; and
one or more interconnect cavities extending into the substrate to expose one or more of the inner layers.

2. The electronic substrate of claim 1, wherein the substrate further comprises one or more electrically conductive surface layers, wherein one or more of the interconnect cavities extends from one of the surface layers to one or more of the inner layers.

3. The electronic substrate of claim 1, wherein each interconnect cavity comprises a base adjacent to one of the inner layers, the base comprising a layer of electrically conductive material.

4. The electronic substrate of claim 1, wherein each interconnect cavity comprises a base adjacent to one of the inner layers, wherein each interconnect cavity defines a wall, the interconnect cavity further comprising a conductive material forming a liner on the wall and base, the liner interconnected with one or more inner layers.

5. The electronic substrate of claim 1, wherein each interconnect cavity comprises a base adjacent to and electrically interconnected with one of the inner layers, wherein one or more interconnect cavity extending from a surface layer defines a wall, the interconnect cavity further comprising a conductive material forming a liner on the wall and base, the liner interconnected with one or more inner layers and the surface layer.

6. The electronic substrate of claim 1, wherein each interconnect cavity is adapted to receive and interconnect with electrically conductive interconnect material.

7. The electronic substrate of claim 1, wherein the interconnect cavities are positioned to correspond with land pads of a surface mount technology electrical component.

8. The electronic substrate of claim 1, wherein each interconnect cavity comprises a base adjacent to one of the inner layers and an opening at a surface of the substrate, the base having a smaller diameter than the opening.

9. The electronic substrate of claim 1, wherein each interconnect cavity comprises a base adjacent to one of the inner layers and an opening at a surface of the substrate, the base having a larger diameter than the opening.

10. A method for making a substrate for interconnecting electronic components comprising:
providing a substrate having one or more electrically conductive inner layers; and
forming a cavity extending from a surface of the substrate, the cavity exposing one or more inner layers.

11. The method of claim 10, wherein providing a substrate having one or more electrically conductive inner layers comprises providing a substrate having one or more electrically conductive inner layers and one or more electrically conductive surface layers; and wherein forming a cavity extending from the surface of the substrate, the cavity exposing one or more inner layer comprises forming a cavity extending from one of the surface layers to one or more inner layers.

12. The method of claim 11, further comprises depositing an electrically conductive material to form a liner in the cavity which is interconnected with the corresponding one or more inner layers and the surface layer.

13. The method of claim 12, wherein depositing an electrically conductive material comprises electroplating a layer of conductive material on walls of the cavity.

14. The method of claim 12, wherein depositing an electrically conductive material comprises using a vapor deposition process to form a layer of conductive material on the cavity walls.

15. The method of claim 10, wherein forming a cavity comprises using laser ablation.

16. The method of claim 10, wherein forming a cavity comprises using a resist mask and an etching process.

17. The method of claim 10, wherein forming a cavity comprises forming a cavity with a base having a smaller diameter than an opening at the surface of the substrate.

18. The method of claim 10, wherein forming a cavity comprises forming a cavity with a base having a larger diameter than and opening at the surface of the substrate.

19. An electronic device comprising:
an electronic component having component interconnects; and
an electronic substrate for interconnecting electronic components comprising:
a substrate having one or more conductive inner layers; and
one or more interconnect cavities extending into a surface of the substrate to expose one or more of the inner layers.

20. The electronic device of claim 19, wherein the substrate further comprises one or more electrically conductive surface layers, wherein one or more of the interconnect cavities extends from one of the surface layers to one or more of the inner layers.

21. The electronic device of claim 19, wherein each interconnect cavity comprises a base adjacent to one of the inner layers, the base comprising a layer of electrically conductive material.

22. The electronic device of claim 19, wherein each interconnect cavity comprises a base adjacent to one of the inner layers, wherein each interconnect cavity defines a wall, the interconnect cavity further comprising a conductive material forming a liner on the wall and base, the liner interconnected with one or more inner layers.

23. The electronic device of claim 19, wherein the electronic component is a microelectronic die.
